(19) United States
(12) Patent Application Publication
(10) Pub. No.: US 2008/0086407 A1
(43) Pub. Date: Apr. 10, 2008

(54) Method and System for Buying and Selling Real Estate at an Optimal Price on the Internet

(76) Inventor: Ajaindra Prakash Singh, Glasgow (GB)

Correspondence Address: LISA J. ALLEN;ALLEN & BROWN, WELL HOUSE, HIGH STREET, KEMPSFORD, GL7 4EU, omitted

(21) Appl. No.: 11/781,303

(22) Filed: Jul. 23, 2007

Related U.S. Application Data
(60) Provisional application No. 60/850,069, filed on Oct. 10, 2006.

(51) Int. Cl. G06Q 30/00; G06Q 50/00

(52) U.S. Cl. 705/37; 705/26; 705/39; 705/400

(57) ABSTRACT

The present invention provides a reverse auction method and system, whereby upon payment of a fee, a seller uploads details of the property to be auctioned onto the auction system web-site provided by the manager of auction system. The system utilizes the information provided to set the necessary parameters of the auction. Many buyers make bids by haggling the price down and a must make an online payment per bid submitted, and the winner is a buyer who makes a lowest “unique” bid when the auction is concluded. All money paid into the system for bid submissions is held in a common pool to make up the difference in winning bid paid and property value. The bid-winner is satisfied by buying the property at a low price, the seller gets full value for his property and the auction system manager is compensated by the seller listing fees and possibly a fractional retention of interest in the property sold.

### CROSS-REFERENCES TO RELATED APPLICATIONS

This patent application is related to and claims priority from U.S. Provisional Patent Application Ser. No. 60/850,069 filed Oct. 10, 2006 entitled METHOD AND SYSTEM FOR BUYING AND SELLING REAL ESTATE AT AN OPTIMAL PRICE ON THE INTERNET which application is incorporated herein by this reference thereto.

### FIELD OF THE INVENTION

The present invention relates generally to a method and system for transacting real estate on-line. More specifically, the present invention involves an internet based method and system which allows potential purchasers to purchase real estate assets at a discount without the seller of such property having to offer any such discount, thereby enabling real estate to be traded at an optimal price from both the buyers' and sellers' perspective.

### BACKGROUND OF THE INVENTION

In conventional market, real estate is bought and sold via real estate agents or at forward auctions. However, the internet also provides unconventional means for buying and selling of properties. Such transactions on the internet also follow the conventional method whereby seller offers to sell the property at a stated price and if buyers are willing to buy at that price the seller sells the property. Some element of negotiation may take place but this may not result in substantial savings for buyers. On the other hand on-line auctions for property are rare. Nevertheless, one may occasionally come across properties being auctioned on-line on web-sites such as www.ebay.com. However, again such auction takes the conventional form of a forward auction where the highest bidder gets the property. This approach again does not allow buyers to benefit substantially in financial terms since price rises with every bid.

In this context, a reverse auction, such as the Internet-based auction method (U.S. Pat. No. 7,024,376) may be useful. However, reverse bids are usually available only to large businesses or to those who are buying in bulk. In such an approach, buyers name the price at which they are willing to buy and vendors try to match the price. Hence, the vendors have to compete against each other to sell goods and services at a lower price rather than buyers bidding by lowering prices. Here, the suppliers have to reduce their selling price in order to be able to sell their goods and services.

Another popular on-line buying and selling option is the unique lowest bidding where by a bidder who has bid for the lowest unique bidding is the one who is able to obtain the goods and services. There are various web-sites such as www.unique-bid.com, www.auctionair.com and www.bidclever.com offering bidders the opportunity to bid for goods and services at lowest possible prices. The disadvantage of this method is that sellers wishing to sell through such web-sites have to offer significant discounts to attract potential purchasers. Hence, such approach will not have wider appeal when it comes to selling real estate where owners do not want to accept absurdly low price for their properties. Furthermore, such practice allows only the operator of such web facility to sell the properties or services they choose on the internet and does not allow third party or external private sellers to put their goods or services up for reverse auction.

Most importantly, the nature of real estate is such that the owners are rarely willing to sell their properties at a discount unless there is a pressing need to do so. On the other hand, buyers, especially first time buyers are being forced out of the market due to ever increasing house prices. Likewise, all real estate transactions are vulnerable to the market cycle. For example, in seller's market, the buyers may be priced out of the market. On the other hand, in buyer's market, the seller may find it difficult to sell their property without offering a discount.

What is therefore needed is a system and method which allows the buyers to buy a property at a discount and the seller to sell the same property at its full market price, irrespective of the market condition. The present invention offers this opportunity.

### SUMMARY OF THE INVENTION

In view of the foregoing disadvantages inherent in the known types of auctions now present in the prior art, the present invention provides a new means by which reverse auctions may occur wherein the sellers of real property can realize their full value while bidders can purchase property at low prices.

The general purpose of the present invention, which will be described subsequently in greater detail, is to provide a real property reverse auction system which is not anticipated, rendered obvious, suggested, taught, or even implied by any of the prior art auctions or auction methods, either alone or in any combination thereof.

In view of the foregoing disadvantages inherent in the known types of auction systems now present in the prior art, the present invention provides a coordinated system by which a person may sell his property for full value while allowing buyers to purchase property at discounted prices.

The general purpose of the present invention, which is described in greater detail below, is to provide an integrated reverse auction sales method by which sellers can market their property to potential buyers at lower costs than using an estate agent but still receive full market value. Properties can be purchased at discounted prices whereby making it easier for property buyers to get on the property ladder as well as for investors to maximize their profits.

The system allows potential seller to upload the full details of the property to be auctioned on the web-site offering such service upon a payment of a fee. The seller also must provide additional details including the full market value of the property to the web-site operator. The information thus obtained will then be used to arrive at lowest acceptable bid; timeframe within which the bid must be complete; the price per bid and the number of bids required. Once this information have been arrived at and posted on the website, the system then notifies registered members to bid for the property. The bidders will make an on-line payment per bid and be able to bid for the property within the set parameters. They have to bid for a unique lowest price. The successful bidder will be the one who has the lowest unique bid which has not been offered to any other bidder. The amount paid by the bidders goes into a common pool.

When the required minimum numbers of bid are received, the system selects and informs the successful bidder. The successful bidder pays the amount equivalent to the bid offered to the seller. Any difference between the market valuation of the property as indicated by the valuation report and the amount paid by the bidder will be met from the common pool. Then the buyer takes possession of the property.

In an alternative embodiment, the website owner may require that the successful bidder must treat a proportion of the contribution met from the common pool as the share of the owner of the web-site. This could also be held on behalf of other unsuccessful bidders and the owner. Such portion can be set by the owner of the web-site or calculated by the system. The remaining portion can then be treated as a discount achieved.

A further alternative is to let bidders choose how much discount the successful bidders should be entitled to and what portion should be retained on behalf of unsuccessful bidders. The discount is then calculated by the system without human interference based on the amounts chosen by bidders.

As a result, the reverse lowest auction process produces opportunity for the buyers to obtain a real-estate property at a discount and at the same time allowing the sellers to sell the property as its full market price, which otherwise would not have been possible had they chosen a conventional method of buying and selling properties. Moreover, in the alternative embodiments of this invention, the system also enables the web-site owner and possibly unsuccessful bidders to collectively own a share in the property bought by the successful bidder.

### DETAILED DESCRIPTION OF THE INVENTION

The present invention provides a method and system for transacting real estate at an optimal price for both the buyers and sellers. The system and method consists of four phases, wherein phase one generates details of property offered for sale through reverse auction, phase two alerts and allows potential buyers to bid at the reverse auction, phase three identifies and alerts the successful bidder and phase four allows the difference between the market value of the property thus sold and the successful bid to be funded from the common pool created by the contribution of all the bidders.

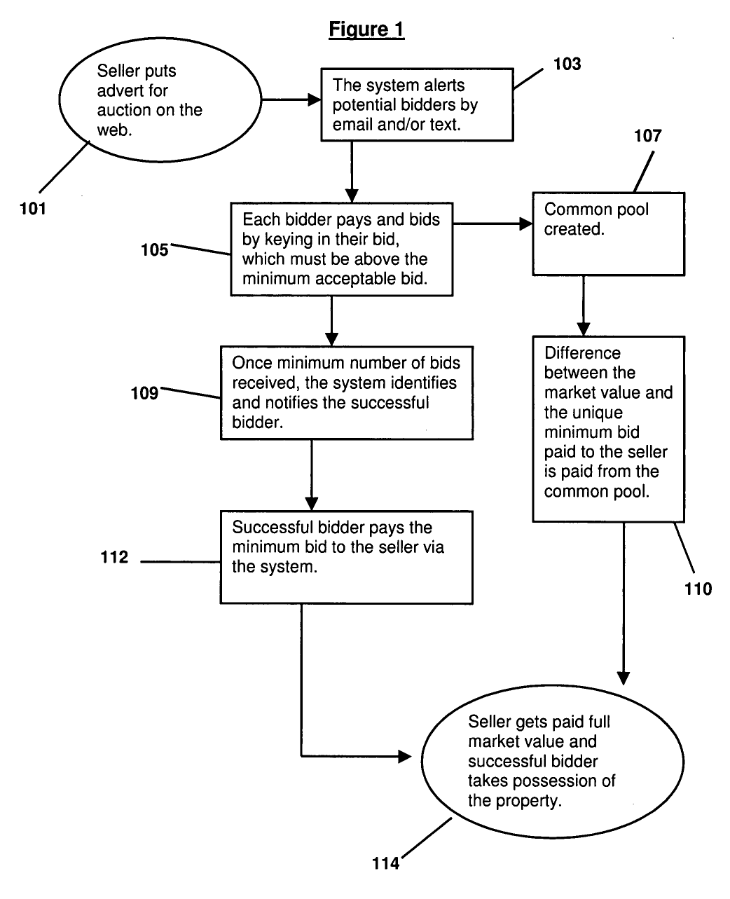

In the following detailed description, like reference numerals are used to refer to various elements of the invention shown in multiple figures thereof. Referring now to the drawings, and particular to FIG. 1, the reverse auction and common pool method of the present invention comprising a four-phase process is shown.

Phase One: In phase one, a potential seller uploads photographs, market value information and a description of the property to be sold through reverse auction using an input device such as a personal computer (PC) (101). Based on the market value of the property, the administrator of the system then sets the minimum acceptable bid along with the minimum number of bids which must be received and the price per bid which must be paid by the bidders for each bid they make. While the seller can provide his own market valuation report, there is also has the option of allowing the system to alert an independent assessor and valuer to commission a survey on behalf of the owner.

The seller (101) utilizes an input device such as a PC to access a website associated with the reverse auction and common pool method. The reverse auction-common pool web site includes a server and any combination of hardware and software necessary to carry out the functions described herein.

Phase two: Once the details have been posted, the system then alerts the potential bidders (103) whose details exist in the system's database, about the new property up for auction by sending emails to their computers and/or text messages to their mobile phones. The purchasers can then view one or more web pages associated with the reverse auction-common pool process. From one of the web pages, the purchasers provide payment details and enter their unique lowest bid (105).

The server associated with the reverse auction-common pool web site receives the data pertaining to the bid and deposits the money received for each submitted bid into a common pool (107) from which sellers are paid the difference between the winning bid and the market value (110).

Phase three: Once the minimum required numbers of bids are received, the system identifies the winning bid and alerts the successful bidder by email/text message along with instruction on how much and when the payment is to be made (109).

Phase four: Once the successful bidder pays the bid amount through the system to one of the designated attorneys. The difference between the actual market value of the property and the bid amount will be paid by the web-site owner from the common pool (110) enabling the buyer and the seller to close the deal (114).

The alternative being that the system then calculates what portion of the contribution from the common pool shall be treated as discount and what portion to be treated as the owner's share in the property. The successful bidder's share in the property will be more equivalent to the amount the bidder has paid plus the discount offered to him by the web-site.

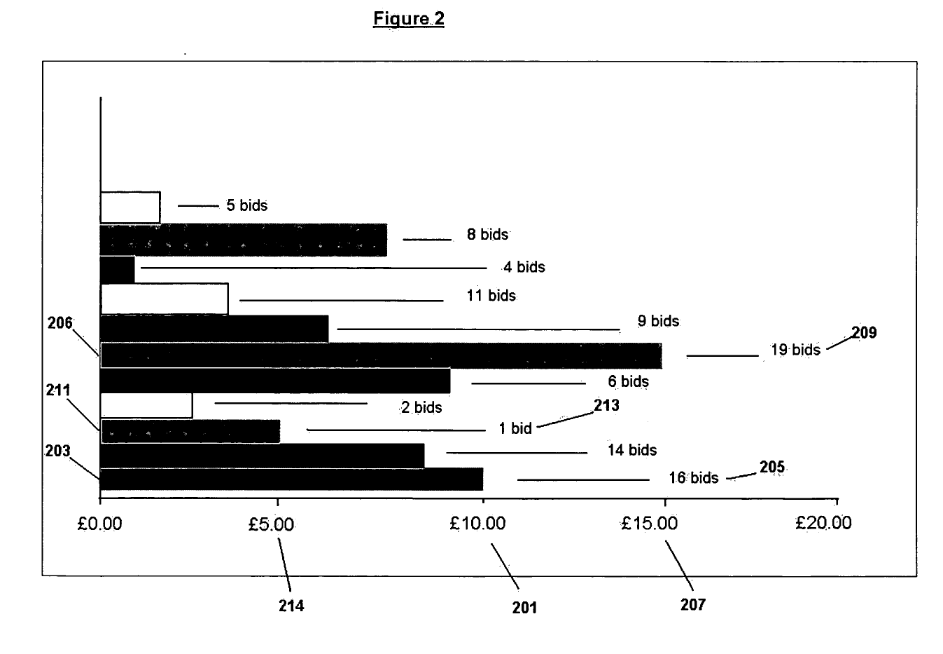

Now, referring to FIG. 2 where the method for determining lowest unique bid is illustrated. The shaded bar graph (FIG. 2) indicates how many bids of each amount was received for a given auction. For example, a bar (203) represents a bid of £10.00. Next to bar (203), there is data (205) showing that 16 bids of £10.00 were placed in this auction. Additionally, a bar (206) represents a bid of £15.00 and the data (209) shows that 19 bids of £15.00 (207) were placed. As the bar (211) and data (213) indicate, there is only one bid (213) placed equal to £5.00 (214), this bidder will be considered to be the successful bidder by the system.

The present invention has the following benefits listed below:

1. The present invention is an innovative reverse auction system based on bidders competing to lower the price, FIG. 1(105) in order to win the property at the lowest possible cost (FIG. 2) at the end of the auction but which still satisfies not only the bid-winner, but the seller and auction system manager as well.

2. This system allows for the seller to receive full market value for the property by requiring bidders to pay a set fee for each bid submitted that is held in a common pool, FIG. 1 (107), which is used to make up the difference in the winning bid and the full market value of the property, FIG. 1 (110).

3. The web-site owner has the option of requiring retention of a fractional interest in each property purchased through his web-site in addition to the listing fees generated by sellers uploading their properties for auction. Thereby maintaining an investment portfolio and maximizing profitability for the company.

4. Using this system buyers and sellers are somewhat insulated from the cyclic ups and downs of the real estate market which can have great influence in traditional property sales methods.

Although preferred embodiments of the present invention have been shown and described, various modifications and substitutions may be made thereto without departing from the spirit and scope of the invention. Accordingly, it is to be understood that the present invention has been described by way of illustration and not limitation.

I claim:

1. A method for conducting a real estate auction via a communications network such as an Internet website comprising the steps of;
(a) a seller accessing the property auction website;
(b) the seller uploading specific real estate property sales information regarding a property for sale to the website;
(c) setting parameters of the auction on the website using the property sales information uploaded by the seller;
(d) allowing prospective bidders to register to bid on properties for sale;
(e) making said listing information available to prospective bidders;
(f) registered bidders place bids on the website;
(g) collecting a fee for each bid placed from registered bidders;
(h) creating and maintaining a common pool of money funded by the fees collected from bidders;
(i) determining which bidder has placed the lowest unique bid; and
(j) awarding the property to the lowest unique bidder.

2. A method for conducting a real estate auction via a communications network such as an Internet website as set forth in claim 1, further comprising:
collecting a fee for said seller uploading specific real estate property sales information regarding a property for sale to the website.

3. A method for conducting a real estate auction via a communications network such as an Internet website as set forth in claim 1, further comprising:
said specific real estate property sales information includes photographs, description and market value of the property.

4. A method for conducting a real estate auction via a communications network such as an Internet website as set forth in claim 1, further comprising:
said setting parameters using sales information details provided by the seller including calculation of lowest acceptable amount allowed as determined by real value of the property.

5. A method for conducting a real estate auction via a communications network such as an Internet website as set forth in claim 5, further comprising:
said setting parameters using sales information details provided by the seller including calculation of minimum number of bids accepted as determined by combining the real value of the property and the lowest acceptable amount of bid accepted.

6. A method for conducting a real estate auction via a communications network such as an Internet website as set forth in claim 6, further comprising:
selection and notification of the successful bidder when the required minimum numbers of bids are received.

7. A method for conducting a real estate auction via a communications network such as an Internet website as set forth in claim 1, further comprising:
said making the listing information available to prospective bidders facilitated via email, text message or other electronic means of communication.

8. A method for conducting a real estate auction via a communications network such as an Internet website as set forth in claim 1, further comprising:
collecting the winning bid amount from winning bidder.

9. A method for conducting a real estate auction via a communications network such as an Internet website as set forth in claim 8, further comprising:
combining winning bid money collected from the bidder with money from the common pool to pay the seller the total value of the property.

10. A method for conducting a real estate auction via a communications network such as an Internet website as set forth in claim 10, further comprising:
said website setting a percentage of ownership to be retained in the property sold to the winning bidder which is held on behalf of the website owner and unsuccessful bidders on the property.

11. A method for conducting a real estate auction via a communications network such as an Internet website as set forth in claim 11, further comprising:
said winning bidder treating a portion of said money paid from the common pool as a share of ownership to be retained in the property sold to be held on behalf of the website owner and unsuccessful bidders on the property.

12. A method for conducting a real estate auction via a communications network such as an Internet website as set forth in claim 11, further comprising:
said winning bidder paying an additional fee for services rendered by said website owner.

13. A system for conducting a real estate auction via a communications network such as an Internet website comprising;
(a) a computer server;
(b) a website administrator;
(c) a property auction website hosted on said computer server and maintained by said website administrator;
(d) a software program customized to facilitate operation of said website;
(e) a secure database used to collect and hold information;
(f) property sellers who access the property auction website via an input device means;
(g) means for uploading specific real estate property sales information regarding a property for sale to the website by the seller onto said database;
(h) means for setting parameters of the auction on the website using the property sales information uploaded by the seller;
(i) a plurality of prospective bidders register their details into said database using an input device means to bid on properties for sale;
(j) means for making said real estate property sales information available to prospective bidders;
(k) a plurality of registered bidders to place bids on the website by using said input device means to send bid information to said server;
(l) means for collecting fees for each bid placed from registered bidders and uploading of property by seller;
(m) means for creating and maintaining a common pool of money funded by the fees collected from bidders;
(n) means for determining which bidder has placed the lowest unique bid; and
(o) means for awarding the property to the lowest unique bidder.

14. A system for conducting a real estate auction via a communications network such as an Internet website comprising as set forth in claim 14 further comprising;
said input device means used by sellers and bidders to access said website is a PC.

15. A system for conducting a real estate auction via a communications network such as an Internet website comprising as set forth in claim 14 further comprising;
said means for making said real estate property sales information available to prospective bidders includes the use of email and text messaging.

16. A method for conducting a real estate auction via a communications network such as an Internet website comprising the steps of;
(a) a seller accessing the property auction website;
(b) uploading specific real estate property sales information regarding a property for sale to the website by the seller;
(c) setting parameters of the auction on the website using the property sales information uploaded by the seller;
(d) said parameters include minimum number of bids needed combined with lowest acceptable amount of bid;
(e) allowing prospective bidders to register to bid on properties for sale;
(f) making said listing information available to prospective bidders;
(g) registered bidders place bids on the website;
(h) collecting a fee for each bid placed from registered bidders;
(i) creating and maintaining a common pool of money funded by the fees collected from bidders;
(j) determining which bidder has placed the lowest unique bid;
(k) collecting the winning bid amount from winning bidder;
(l) combining winning bid money collected from the bidder with money from the common pool to pay the seller the total value of the property; and
(m) awarding the property to the lowest unique bidder.
